(19) United States
(12) Patent Application Publication
(10) Pub. No.: US 2021/0362932 A1
(43) Pub. Date: Nov. 25, 2021

(54) SAMPLER FOR COSMETIC OR FRAGRANCE POWDERY MATERIAL AND METHOD

(71) Applicant: AKI, Inc., Chattanooga, TN (US)

(72) Inventors: Mickael Devassine, Ooltewah, TN (US); Hrazhyna Devassine, Ooltewah, TN (US)

(73) Assignee: AKI, Inc., Chattanooga, TN (US)

(21) Appl. No.: 17/303,053

(22) Filed: May 19, 2021

Related U.S. Application Data
(60) Provisional application No. 63/026,950, filed on May 19, 2020.

(51) Int. Cl. B65D 81/24; A45D 33/00; B65D 81/22; B65D 75/30

(52) U.S. Cl. CPC B65D 81/245; A45D 33/005; B65D 81/22; B65D 2221/00; A45D 2200/051; A45D 2200/10; B65D 75/30

(57) ABSTRACT

A sampler for fragrance or cosmetic powdery material such as make up, blush, eyeshadow, and the like. The powder can be dispersed in a liquid such as a fragrance or a volatile solvent before application to a bottom layer. The solvent is removed before a top layer is applied over the sample optionally without an intermediate layer. A peripheral seal such as a repositionable glue or heat-seal, or both, is formed between the top and the bottom layers. The seal is separable by a user pulling on a tab located on one side to expose the face of the bottom and to allow the material to be sampled. The sampler has a slim profile, which can be efficiently manufactured with a roller application process, and is particularly suited for placement in magazines, flyers, newspapers, postcards, and the like.

### CROSS REFERENCE TO RELATED APPLICATIONS

This application claims priority to U.S. Provisional Application Ser. No. 63/026,950, filed May 19, 2020, which is incorporated herein by reference in its entirety.

### FIELD OF THE APPLICATION

The disclosed subject matter generally relates to a cosmetics sampler, and more particularly to a sampler for cosmetic or fragrance powder.

### DESCRIPTION OF THE RELATED ART

The field of cosmetics and fragrance is a popular and competitive industry. These products come in many forms, including liquids, sprays, creams, and the like. Powdery cosmetics and fragrance products such as blush, eye shadow, and the like are a popular choice. With such a high number of cosmetics and fragrances available to consumers, it is desirable to present products in samplers to allow consumers to easily identify the fragrance or cosmetic of interest.

Co-pending U.S. patent application Ser. No. 16/988,838 describes a sampler for a scented waxy candle material wherein melted scented material is disposed between top and bottom vapor barrier layers by a roller applicator.

U.S. Pat. No. 5,439,172 describes a planar sampler for a liquid volatile material such as a perfume.

U.S. Pat. No. 5,562,112 describes a sampler for lipstick with a coated cover stock, upon which a lipstick is screen printed in any desired pattern. A perimeter adhesive is applied to the coated face stock and a clear cover sheet is laminated over the lipstick. The cover serves to prevent offset and projects the image of a clean, sanitary product.

U.S. Pat. No. 6,282,652 describes a fluid sampler including a transparent composite laminate sealed with a composite laminate having a foil barrier layer.

U.S. Pat. No. 6,326,069 describes a fluid sampler pouch with internal supportive structure within a cavity allowing the peel seal to withstand compressive force.

U.S. Pat. No. 9,475,615 describes a resealable label composed of a top layer and a bottom layer. The two layers adhere together via an adhesive layer. The bottom layer includes a concave perforation having a line defined by endpoints of the concave perforation.

U.S. Pat. No. 4,938,462 describes resealable packages, and more particularly a resealable blister type package for displaying packaged goods in a container which can be opened and resealed without obvious or apparent damage.

U.S. Patent Publication No. 2010/0002963 describes a reclosable food package, which has an easily accessed yet airtight seal via the use of a tamper evident rupture strip which provides the container or package with improved shelf life for the product contained therein.

U.S. Patent Publication No. 2005/0061710 describes a fragrance sampler for inserting into printed matter such as a magazine or a mass mailing. The sampler is made from a bottom ply and a top ply of material and an applicator.

U.S. Pat. No. 5,326,564 describes a spherical resealable cosmetic product having a first and second section. Each section is defined by a hemispheroidal chamber having an open mouth with a circumferential edge therearound and a flange projecting outwardly therefrom.

While there are known samplers for cosmetics and fragrances, there remains a need for a more effective sampler for powdery cosmetics and fragrance materials as well as a more efficient method of production.

### SUMMARY

The purpose and advantages of the disclosed subject matter are set forth in the following description, and additional advantages may be obtained by the practice and knowledge of those skilled in the art based on this description.

The disclosed subject matter provides, according to some embodiments, a new sampler for a powdery material (e.g., fragrance or cosmetic) sample including a sample of a powdery material applied to a selected area of a vapor barrier bottom layer, a vapor barrier top layer applied optionally without an intermediate layer over the selected area of the bottom layer, and a seal between the periphery of the bottom and top layers forming a barrier enclosure.

According to some embodiments, to prevent unwanted release of any odorous or volatile molecules in the powdery material, the sampler includes a repositionable adhesive seal, or a peelable perimeter seal (e.g., heat seal), or both, and a tab for the user to open the sampler and sample the contained powdery material. When a repositionable adhesive seal is used, the sample can be resealed for later use.

The slimness and flexibility of the sampler allow for placement upon or between pages of magazines, flyers, newspapers, postcards, and the like. The sampler can be used as an advertisement allowing the reader to discover the scents of the fragrance powder or to test the color cosmetic powder on the skin.

The foregoing summary and the following detailed description are exemplary and are intended to provide an explanation of the disclosed subject matter, which is further illustrated and explained by the accompanying drawings.

### BRIEF DESCRIPTION OF THE DRAWINGS

FIG. 1 is a vertical cross-sectional view of an exemplary sampler in accordance with the disclosed subject matter.

FIG. 2 is a top view of an exemplary sampler in accordance with the disclosed subject matter.

FIG. 3 is a side view of an exemplary manufacturing process of a sampler in accordance with the disclosed subject matter.

FIG. 4 is a side view of an exemplary roller application process in accordance with the disclosed subject matter.

FIG. 5 is a top view of an exemplary sampler in accordance with the disclosed subject matter.

FIG. 6 is a vertical cross-sectional view of an exemplary sampler in accordance with the disclosed subject matter.

### DETAILED DESCRIPTION

The sampler for cosmetic or fragrance powder presented herein allows a user to sample powdery materials such as cosmetics and fragrances in a slim-profile sampler, which can be efficiently manufactured with a roller application process, also described herein. The sampler is particularly suited for placement upon or between pages of magazines, flyers, newspapers, postcards, and the like, and can be used as an advertisement allowing the reader to discover the scents of the fragrance powder or to test the color cosmetic powder on the skin.

An exemplary sampler for a powdery material (e.g., fragrance or cosmetic) includes a sample of a powdery material applied directly to a selected area of a first face of a vapor barrier bottom layer, a vapor barrier top layer applied directly and without an intermediate layer over at least said selected area of the said first face of the bottom layer, and a seal between at least the periphery of said bottom and top layers whereby there is formed a barrier enclosure. The term “powdery material” is used throughout this application to refer to any sample material suitable for use with the disclosed sampler such as cosmetic products (e.g., blush, eye shadow), powdery fragrances, and the like.

According to some embodiments, a seal between at least the periphery of the bottom and top layers form a vapor barrier enclosure containing the sample. A user can separate at least part of said top layer from the bottom layer to expose at least part of the sample for allowing the fragrance to escape into the air or sampling the cosmetic. By using repositionable glue as the sealant, the top layer can be designed to be resealed to the bottom layer to prevent further release of volatile molecules in the sample.

The disclosed subject matter also provides a process for manufacturing the disclosed sampler including applying a powdery material directly to a selected area of a first face of a vapor barrier bottom layer, applying a vapor barrier top layer over at least said selected area of said first face of the bottom layer, and forming a vapor barrier seal between the bottom and top layers. That seal can form a vapor barrier enclosure for the volatile molecules in the case of a fragrance.

The powdery material can be dispersed in a fragrance or in a volatile solvent such as water, hydrocarbons (e.g., Isopar K, dodecane) to make a slurry that can be applied to the sampler. The solvent can be removed to obtain a dry powder in the case of a cosmetic product. A stabilizer can be added to the mixing to stabilize the product. A surfactant can be added to disperse the powder in the liquid more easily.

In some embodiments, the powdery material in slurry is applied to an intermediate pad and transferred to the base layer. The pad can be in any shape (e.g., disc, rectangle).

In some embodiments, the powdery material is applied to a substantially central area of a substantially vapor impermeable plastic or laminate sheet bottom layer, which can be in the form of disc, rounded rectangle, or the like. The top layer is provided by a corresponding layer of the same or another plastic or laminate sheet material. The seal between the bottom and top layers can be formed by surface-to-surface contact adhesion between the opposed faces of the bottom and top layers, or by an adhesive or other bonding (e.g., heat-sealing, Radio-Frequency sealing) between the opposed faces of the bottom and top layers.

In embodiments, such a seal is formed around the periphery of the contacting opposed faces of the bottom and top layers and is conveniently radially inset from the edges of the layers over at least part of its length to provide an unbonded tab or edge which can be gripped by the user to separate the bottom and top layers when desired.

Reference will now be made in detail to the various exemplary embodiments of the disclosed subject matter, which are illustrated in the accompanying drawings. The structure and corresponding methods of operation of the disclosed subject matter will be described in conjunction with this detailed description.

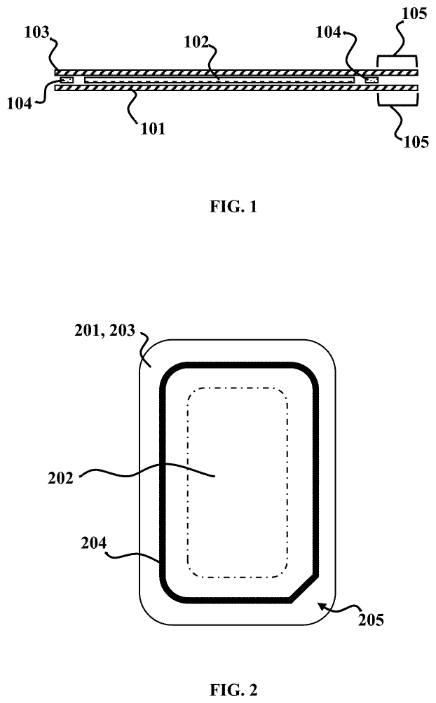

The accompanying figures, where like reference numerals refer to identical or functionally similar elements throughout the separate views, serve to further illustrate various embodiments and explain various principles and advantages all in accordance with the disclosed subject matter. For purpose of explanation and illustration, and not limitation, exemplary embodiments of the sampler for cosmetic or fragrance powder in accordance with the disclosed subject matter are shown in FIGS. 1-6.

For purpose of illustration, and not limitation, reference is now made to FIG. 1, which shows a vertical cross-sectional view of an exemplary sampler for cosmetic or fragrance powder. In this embodiment, the sampler comprises a bottom barrier layer 101 on which a sample of powdery material 102 is applied, and over which a top barrier layer 103 is applied. A seal ring of adhesive 104 or other suitable sealing bond is placed around the periphery of the bottom layer 101 to keep the top layer 103 in place, to protect the sample 102, and to prevent unwanted release of any odorous, volatile molecules in the sample 102, such as in the case the sample 102 is a powdery fragrance.

The bottom layer 101 can be made from odorless, plastic materials which are not degraded or dissolved by the fragrance or solvent used to make the slurry and will present good barrier properties in the case of a fragrance sampler. Examples of suitable materials for the bottom layer 101 are polyolefins, such as polyethylenes, polypropylenes, polyester, and the like.

Preferred polymers for use in the bottom layer 101 are polyester polymers, e.g. polyethyleneterephtalate. The bottom layer 101 can also be a laminate of two or more different materials. For example, a polyethylene or an amorphous polyester upper layer with a polyester under layer, bonded together by an adhesive interface such as a polyacrylic adhesive. This kind of laminate may be selected if a peelable heat-seal is desired.

In some embodiments, the bottom layer 101 is treated (e.g., by corona discharge) or coated in order to enhance the adhesion of the powdery material 102 and any adhesive to the surface of the polymeric bottom layer material.

The top layer 103 can be made from the same or similar materials as the bottom layer 101. The top layer 103 can be treated or coated to aid the adhesion of any adhesive or printing thereto.

The sample of powdery material 102 can be applied directly to the bottom layer 101 in liquid form (slurry) after dispersion with a fragrance or an appropriate solvent. The solvent may be water or an organic oil such as a hydrocarbon (isoparaffin, linear alkanes . . . ). The addition of the diluent such as a vegetable oil (isopropyl palmitate, isopropyl myristate . . . ), a silicone may help to adjust the rendition in the case of a fragrance powdery sample.

The amount of powdery material 102 in the form of a slurry which is applied to the bottom layer 101 can be adjusted having regard to the strength of the scents desired or the quantity of product available to the customer.

The bottom and top layers 101, 103 can be selected to adhere, or to be sealed to one another and form a vapor barrier seal around the area to which the powdery material has been applied. However, where this is not the case, an adhesive 104 or similar bonding material can be applied, preferably around the area to which the powdery material 102 has been applied to the bottom layer 101. It is preferred to provide at least part of the radially outward edge of the sampler as an unbonded edge or tab 105 so that a user may easily pull off the top layer 103.

The adhesive 104 used to bond the bottom and top layers 101, 103 together may be a water or solvent base adhesive. A pressure sensitive adhesive such as a polyacrylate adhesive or a hot-melt adhesive can be used for example. In the case of the adhesive use with water or solvent that needs to be removed, it is preferred that the removal step is done before the application of the powdery material 102 in order to avoid contaminating the sample. In embodiments, the use of water-based polyacrylic adhesive is preferred.

In some embodiments, the sampler can be printed on the bottom layer 101 and/or the top layer 103. In such cases, the ink can be applied in a separate printing operation from the powder application. This printing may be achieved before or after the application of the powdery material 102 to the bottom layer 101.

As shown in FIG. 2, in some embodiments, the sampler is preferably made by applying an adhesive ring 204 around the sample area 202 of the bottom sheet 201 to which a powdery material is to be applied. Then a top layer 203 is applied over the powder area 202 to form a laminate from which the sampler can be cut, by stamping, for example. In this embodiment, a rectangular sampler is shown, but other suitable shapes such as discs can be used.

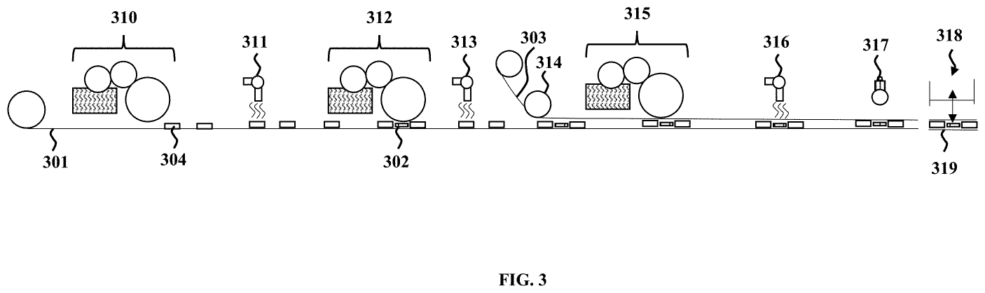

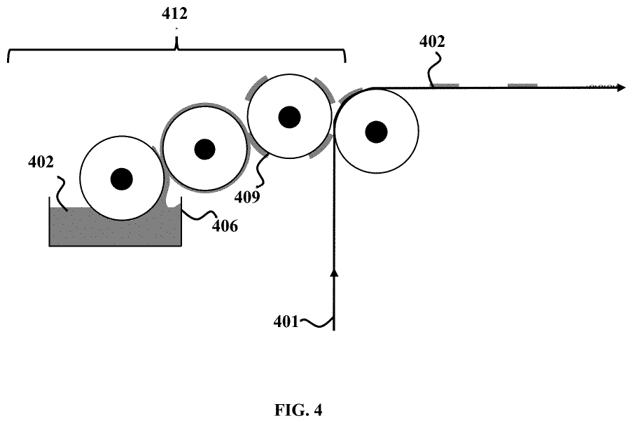

An exemplary process of manufacturing the sampler for cosmetic or fragrance powder is shown in FIGS. 3 & 4. FIG. 3 shows an overview of the manufacturing process, while FIG. 4 shows details of the roller applicators use in the process.

As shown in FIG. 3, in some embodiments, the adhesive 304 is preferably applied to the bottom layer 301 using a conventional sculptured roller applicator 310. The adhesive 304 can be dried by a hot air blower 311 before the application of the powdery material 302, particularly when the adhesive is a water-based product.

After the adhesive 304 is applied and dried, the powdery material sample 302 is applied in slurry form in a similar manner using a conventional sculptured roller applicator 312, and then dried by a hot air blower 313 (or hot tunnel) to remove most liquid from the slurry to create the powdery sample.

Once the adhesive 304 and powdery material 302 are applied on a bottom layer 301, then covered with a top layer by passing the two layers 301 and 303 carrying the adhesive 304 and the powdery material 302 through the nip of a pressure roller 314.

The top layer 303 can then be printed by using a printing unit 315. If necessary or desired, the composite laminate can be heated or dried by a hot air blower 316 or other means to remove residual water or solvent and/or cured, such as by UV light 317.

Alternatively, the top layer 303 can be preprinted before the production of the sampler. In that case, a registration system can be used and the corresponding steps shown in FIG. 3 can be omitted.

At the end of the process, the completed sampler 319 can be separated from the composite by a stamp or an air blade cutter 318 in the desired shape (e.g., rectangle, disc, and the like).

FIG. 4 shows the details of the roller applicators (shown in FIG. 3, items 310, 312, and 315) used to apply the desired liquid (in FIG. 3, adhesive 304, powdery material 302, and printing on the top layer 303). As shown in FIG. 4, the liquid 402 is placed in a bath 406 and applied to the bottom layer 401 using a conventional sculptured roller applicator 412.

The shape of liquid material application 402 can be defined in function of the pad shape 409 used on the roller. For instance, to apply an adhesive ring, a ring-shaped pad can be used. The liquid material 402 can also be applied by a non-contact or ink-jet printer technique.

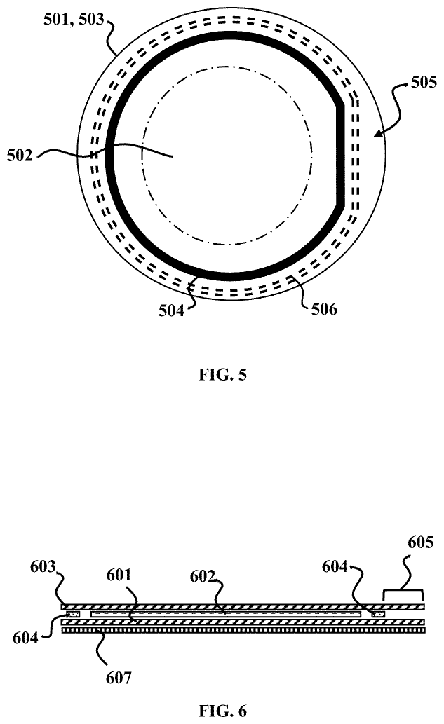

In an alternative embodiment, shown in FIG. 5, the bottom and top layers 501, 503 can be sealed together by heating or by another suitable process, or their surface energy properties can be configured to enable an auto adhesive, such as to form an outer peelable seal 506 around the powdery material 502. In such cases, an adhesive ring 504 can be omitted, or alternatively used in conjunction with the additional seal to allow the sampler to be resealed after breaking the peelable seal by pulling the tab 505. This double seal can improve the fragrance stability and powder containment over an adhesive seal alone.

Optionally, as shown in FIG. 6, an adhesive layer 607 can also be applied to the reverse face of the bottom layer 601 (opposite to the surface to which the powdery material 602 is applied). That adhesive layer 607 allows for placement of the sampler on a carrier such as a card or a newspaper. Top layer 603, adhesive ring 604, and tab 605 can all function as described above with respect to corresponding features shown in previous figures.

An exemplary embodiment of the sampler for a powdery material and method for making the same in accordance with the present disclosure will now be described.

### Example 1

This example describes the process to make a clear sampler containing a cosmetic powder material.

A water-based adhesive (Purethane 20914 Laminating Adhesive from Ashland) is applied in the shape of a rectangular ring to the bottom clear polyester film (coated on the back face by an adhesive and protected by a silicon liner) by using a roller applicator. The adhesive is dried by a hot air blower. Then, a cosmetic powder dispersed in a solvent Isopar K is applied in an area inside the adhesive ring. Then the solvent is removed by heating. The bottom material is covered by a top treated clear polyester film by passing the two films through the nip of a pressure roller. The sampler is cut by a stamp cutter.

The foregoing description of exemplary embodiments, including examples, is presented only to describe, explain, and illustrate the broad concepts of the disclosed subject matter, and is not intended and should not be construed to limit the scope of the of the present disclosure. Various modifications and improvements may be made by those skilled in the art without departing from the scope. Thus, the disclosed subject matter includes all modifications and improvements that are within the scope of the following claims and their equivalents.

What is claimed is:

1. A sampler for a powdery material comprising:
a bottom vapor barrier layer having an upper surface;
a sample of the powdery material disposed on a sample area of the upper surface of the bottom layer;
a top vapor barrier layer disposed over at least the sample area of the upper surface of the bottom layer; and
a seal between the top layer and the bottom layer configured to substantially contain the sample of the powdery material.

2. The sampler according to claim 1 wherein an extending portion of at least one of the layers extends outwardly beyond the seal in the opposite direction from the sample.

3. The sampler according to claim 2 wherein the extending portion extends sufficiently to create a tab suitable for grasping by a human user.

4. The sampler according to claim 1 wherein the seal is formed by utilizing heat.

5. The sampler according to claim 1 wherein the comprises a ring of adhesive material disposed between the sample and outer edges of the top and bottom layers.

6. The sampler according to claim 5 further comprising a second seal between the top layer and the bottom layer formed by utilizing heat.

7. The sampler according to claim 6 wherein the second seal is disposed radially outward from the ring of adhesive.

8. The sampler according to claim 1 further comprising an adhesive layer applied to a lower surface of the bottom layer.

9. The sampler according to claim 1 wherein at least a portion of the sample area of the upper surface of the bottom layer is coated to enhance adhesion to the sample.

10. The sampler according to claim 1 wherein the bottom layer and the top layers are made of materials selected not to degrade when the sample is disposed thereon.

11. The sampler according to claim 1 wherein the bottom layer comprises a laminate of at least two materials.

12. The sampler according to claim 1 wherein the sample is dispersed in a volatile solvent.

13. The sampler according to claim 12 wherein the solvent is a fragrance, water, or hydrocarbons.

14. The sampler according to claim 1 wherein the sample contains a stabilizer.

15. A process for manufacturing a sampler for a powdery material comprising:
providing a vapor barrier material for a bottom layer of the sampler;
providing a vapor barrier material for a top layer of the sampler;
providing a liquid sample material for depositing in the sampler;
depositing the liquid sample material on an upper surface of the bottom layer;
drying the liquid sample material to create a substantially powdery sample; and
sealing the top layer to the bottom layer.

16. The process for manufacturing a sampler for a powdery material according to claim 15 wherein the liquid sample material is deposited with a roller applicator.

17. The process for manufacturing a sampler for a powdery material according to claim 15 wherein the liquid sample material is dried with heat.

18. The process for manufacturing a sampler for a powdery material according to claim 15 wherein the sealing of the top layer to the bottom layer comprises:
providing a liquid adhesive material;
depositing the liquid adhesive material on the upper surface of the bottom layer; and
drying the liquid adhesive material; and
depositing the top layer onto the dried liquid adhesive material.

19. The process for manufacturing a sampler for a powdery material according to claim 18 wherein the liquid adhesive material is deposited with a roller applicator.

20. The process for manufacturing a sampler for a powdery material according to claim 18 wherein the liquid adhesive material is dried with heat.
